(19) United States
(12) Patent Application Publication
(10) Pub. No.: US 2012/0223927 A1
(43) Pub. Date: Sep. 6, 2012

(54) LIQUID CRYSTAL DISPLAY DEVICE AND METHOD FOR DRIVING THE SAME

(75) Inventors: Tsan-ming Hsieh, Dayuan Township (TW); Yi-chiang Lai, Dayuan Township (TW)

(73) Assignee: CHUNGHWA PICTURE TUBES, LTD., Bade City (TW)

(21) Appl. No.: 13/106,843

(22) Filed: May 12, 2011

(30) Foreign Application Priority Data
Mar. 4, 2011 (TW) 100107436

(51) Int. Cl. G09G 5/00

(52) U.S. Cl. 345/211; 345/87

(57) ABSTRACT

A liquid crystal display device and a method for driving the same are disclosed. The liquid crystal display device includes a liquid crystal panel and a driving circuit. The driving circuit includes a timing controller, a detection unit, a level shift circuit, a gate driver unit, and at least one source driver unit. The timing controller receives a frame rate and provides at least one gate turn-on signal and a source data writing signal for each of at least two different frame rates. The detecting unit detects the frame rate. The timing controller adjusts a duty cycle of the source data writing signal, so that the charge time is maintained to be substantially constant for any one of the different frame rates. Accordingly, a problem of flickering phenomenon can be avoided.

### BACKGROUND OF THE INVENTION

1. Field of the Invention

The present invention generally relates to a liquid crystal display device, more particularly, to a liquid crystal display device capable of avoiding a flickering phenomenon when switching a frame rate and to a method for driving the same.

2. Description of Prior Art

A seamless dynamic refresh rate switching (SDRRS) technology, developed by Intel Corporation, is a power saving technology utilized in a liquid crystal display device of a notebook. When the liquid crystal display device of the notebook is in an idle state, a frame rate of the liquid crystal display device can be switched from 60 hertz (Hz) to 40 Hz to achieve power saving. However, when the liquid crystal display device is switched to a different frame rate, a charge time of each liquid crystal capacitor is also changed and thus a flickering phenomenon occurs.

Please refer to FIG. 1A, which illustrates a control signal timing chart of a conventional liquid crystal display device implementing the SDRRS technology at a frame rate of 60 Hz. In the liquid crystal display device, a timing controller (T-Con) controls gate driver integrated circuits (IC) and source driver integrated circuits. As a result, the gate driver integrated circuits turn on gate lines, and the source driver integrated circuits write data to source lines. In FIG. 1A, the control signals with respect to an Nth gate line, an N+1th gate line, and an N+2th gate line, are respectively indicated as N, N+1, and N+2. A ready signal STH and a writing signal LP are transmitted to the source driver integrated circuits by the timing controller. A gate control signal OE is transmitted to the gate driver integrated circuits by the timing controller. When the ready signal STH is at a high level, it is an indication that the timing controller is ready to transmit the data to the source driver integrated circuits. When the writing signal LP is at a high level, the timing controller transmits the data to the source driver integrated circuits. When the writing signal LP is at a low level, the source driver integrated circuits write the data to the source lines. When the gate control signal OE is at a high level, the gate lines are not turned on for preventing two adjacent gate lines from being turned on at the same time, so that the source lines are not written repeatedly. When the gate control signal OE is at a low level, one of the gate lines is turned on.

Firstly, when the timing controller transmits the ready signal STH at the high level to the source driver integrated circuits, it is an indication to inform the source driver integrated circuits that the timing controller is ready to transmit the data of the source lines which are electrically coupled to the Nth gate line to the source driver integrated circuits. When the writing signal LP is at the high level, the timing controller transmits the data of the source lines which are electrically coupled to the Nth gate line to the source driver integrated circuits, meanwhile, the timing controller transmits the gate control signal OE at the high level to the gate driver integrated circuits to prevent the problem that the source lines are written repeatedly. After the data are transmitted to the source driver integrated circuits, the timing controller transmits the gate control signal OE at the low level to the gate driver integrated circuits for turning on the Nth gate line, meanwhile, the timing controller transmits the writing signal LP at the low level to the source driver integrated circuits. The source driver integrated circuits write the data to the source lines which are electrically coupled to the Nth gate line, and liquid crystal capacitors which are electrically coupled to the Nth gate line start to be charged for retaining the data. That is, a charge time of the Nth gate line is a time interval in which the gate control signal OE is at the low level and represented as T1.

When the timing controller transmits the ready signal STH at the high level to the source driver integrated circuits for the second time, it is an indication to inform the source driver integrated circuits that the timing controller is ready to transmit the data of the source lines which are electrically coupled to the N+1th gate line to the source driver integrated circuits. When the writing signal LP is at the high level, the timing controller transmits the data of the source lines which are electrically coupled to the N+1th gate line to the source driver integrated circuits, meanwhile, the timing controller transmits the gate control signal OE at the high level to the gate driver integrated circuits to prevent the problem that the source lines are written repeatedly. After the data are transmitted to the source driver integrated circuits, the timing controller transmits the gate control signal OE at the low level to the gate driver integrated circuits for turning on the N+1th gate line, meanwhile, the timing controller transmits the writing signal LP at the low level to the source driver integrated circuits. Then, the source driver integrated circuits write the data to the source lines which are electrically coupled to the N+1th gate line, and liquid crystal capacitor which are electrically coupled to the N+1th gate line start to be charged for retaining the data. That is, a charge time of the N+1th gate line is a time interval in which the gate control signal OE is at the low level and represented as T1 the same as the charge time of the Nth gate line. The timing control of each of the following gate lines has the same manner as that of the Nth gate line (or the N+1th gate line) and is not described herein.

Please refer to FIG. 1B, which illustrates a control signal timing chart of the conventional liquid crystal display device implementing the SDRRS technology at the frame rate of 40 Hz. The timing control is the same as in FIG. 1A for the ready signal STH, the writing signal LP, and the gate control signal OE. FIG. 1B differs from FIG. 1A in that the frame rate illustrated in FIG. 1B is decreased from 60 Hz to 40 Hz, thus a period of the gate control signal OE is increased. Since a time interval in which the gate control signal OE is at the high level is fixed, it is an indication that a time interval in which the gate control signal OE is at the low level is increased. That is, a charge time at the frame rate of 40 Hz is increased. The charge time at the frame rate of 40 Hz is represented as T2. Since the charge time T2 at the frame rate of 40 Hz is different from the charge time T1 at the frame rate of 60 Hz, the flickering phenomenon occurs when the frame rate is switched.

At present, a method to solve the flickering phenomenon is increasing the time interval in which the gate control signal OE is at the high level so as to decrease the time interval in which the gate control signal OE is at the low level in FIG. 1B, whereby the charge time T2 at the frame rate of 40 Hz is decreased to the charge time T1. As a result, the charge time at the frame rate of 60 Hz is the same as the charge time at the frame rate of 40 Hz (i.e. T1) regardless of the frame rate is 60 Hz or 40 Hz, whereby the flickering phenomenon is avoided.

Recently, a gate-in-panel (GIP) type liquid crystal display (GIP type LCD) device is developed. Additional gate driver integrated circuits are not used in the GIP type LCD device. Driving circuits which are equivalent to a shift register function of the additional gate driver integrated circuits are manufactured on a liquid crystal panel of the GIP type LCD device, whereby the cost of the gate driver integrated circuits is reduced. In addition, the driving circuits can be manufactured in the processes of manufacturing the gate lines, the source lines, and pixels without extra manufacturing processes. When the above-mentioned gate control signal OE is utilized for the timing control in the GIP type LCD, however, the driving circuits are quite complex so that there is no enough space to dispose the driving circuits on the liquid crystal panel.

### SUMMARY OF THE INVENTION

An objective of the present invention is to provide a liquid crystal display device capable of avoiding a flickering phenomenon when switching a frame rate and a method for driving the same.

According to an aspect of the present invention, the liquid crystal display device comprises a liquid crystal panel and a driver circuit. The liquid crystal panel comprises a plurality of gate lines and a plurality of source lines crossing the gate lines. The driver circuit is utilized for driving the liquid crystal panel to display an image. The driver circuit comprises a timing controller, a detection unit, a level shift circuit, a gate driver unit, and at least one source driver unit. The timing controller receives a frame rate and provides at least one gate turn-on signal and a source data writing signal for each of at least two different frame rates. The detection unit detects the frame rate and selects the gate turn-on signal and the source data writing signal corresponding to the detected frame rate from the signals provided by the timing controller. The level shift circuit receives the selected gate turn-on signal corresponding to the detected frame rate. The gate driver unit is disposed on the liquid crystal panel and controls the gate lines of the liquid crystal panel according to the selected gate turn-on signal. The source driver unit writes data to each of the source lines according to the selected source data writing signal. A charge time of each of the gate lines is a time interval in which the gate line is turned on by the gate driver unit according to the selected gate turn-on signal and the data is written to each of the source lines by the source driver unit according to the selected source data writing signal. The timing controller adjusts a duty cycle of the source data writing signal so that the charge time is maintained to be substantially constant for any one of the different frame rates.

In the method for driving the liquid crystal display device in accordance to another aspect of the present invention, the liquid crystal display device comprises a liquid crystal panel and a driver circuit. The liquid crystal panel comprises a plurality of gate lines and a plurality of source lines crossing the gate lines. The driver unit comprises a timing controller, a detection unit, a level shift circuit, a gate driver unit disposed on the liquid crystal panel, and at least one source driver unit. The method comprises the following steps. The timing controller receives a frame rate and provides at least one gate turn-on signal and a source data writing signal for each of at least two different frame rates. The detection unit detects the frame rate and selects the gate turn-on signal and the source data writing signal corresponding to the detected frame rate from the signals provided by the timing controller. The level shift circuit receives the selected gate turn-on signal corresponding to the detected frame rate. The gate driver unit turns on the gate lines of the liquid crystal panel according to the selected gate turn-on signal. The source driver unit writes data to each of the source lines according to the selected source data writing signal. A charge time of each of the gate lines is a time interval in which the gate line is turned on by the gate driver unit according to the selected gate turn-on signal and the data is written to each of the source lines by the source driver unit according to the selected source data writing signal. The timing controller adjusts a duty cycle of the source data writing signal so that the charge time is maintained to be substantially constant for any one of the different frame rates.

In the liquid crystal display device and the method for driving the same of the present invention, the detection unit detects the frame rate and selects controls signals corresponding to the detected frame rate, thus the problem of flickering phenomenon can be avoided.

### BRIEF DESCRIPTION OF THE DRAWINGS

FIG. 1A illustrates a control signal timing chart of a conventional liquid crystal display device implementing the SDRRS technology at a frame rate of 60 Hz;

FIG. 1B illustrates a control signal timing chart of the conventional liquid crystal display device implementing the SDRRS technology at the frame rate of 40 Hz;

FIG. 2 illustrates a liquid crystal display device in accordance with the present invention;

FIG. 3A illustrates a control signal timing chart of the liquid crystal display device of the present invention implementing the SDRRS technology at the frame rate of 60 Hz;

FIG. 3B illustrates a control signal timing chart of the liquid crystal display device of the present invention implementing the SDRRS technology at the frame rate of 40 Hz;

FIG. 4 illustrates an embodiment of the detection unit in FIG. 2 and a detection principle of the detection unit; and

FIG. 5 illustrates a flow chart of a method for driving a liquid crystal display device according to the present invention.

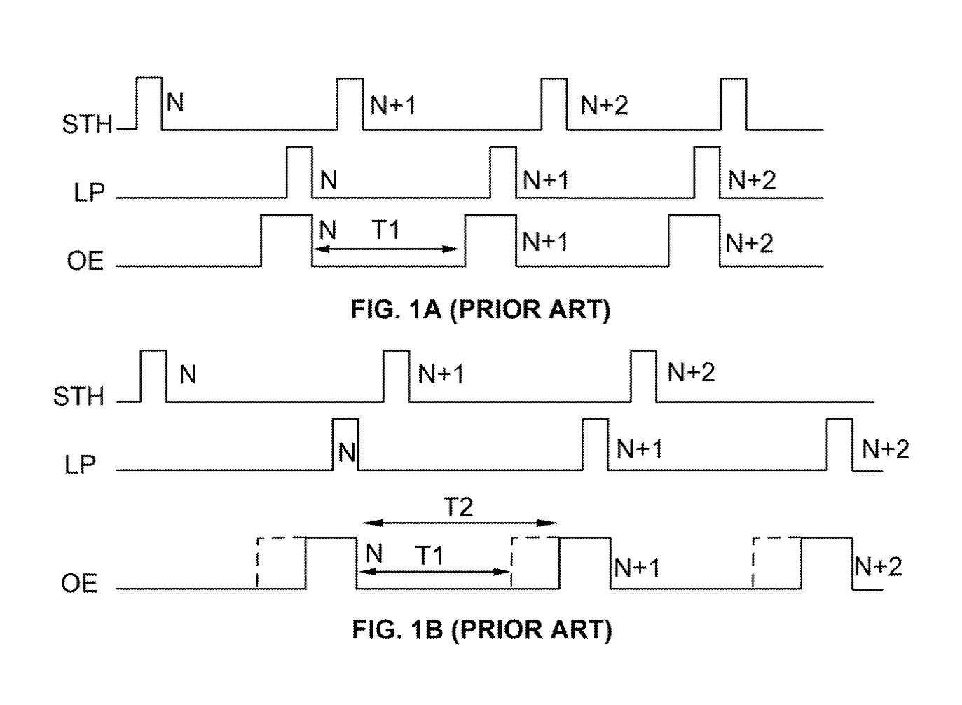

### DETAILED DESCRIPTION OF THE INVENTION

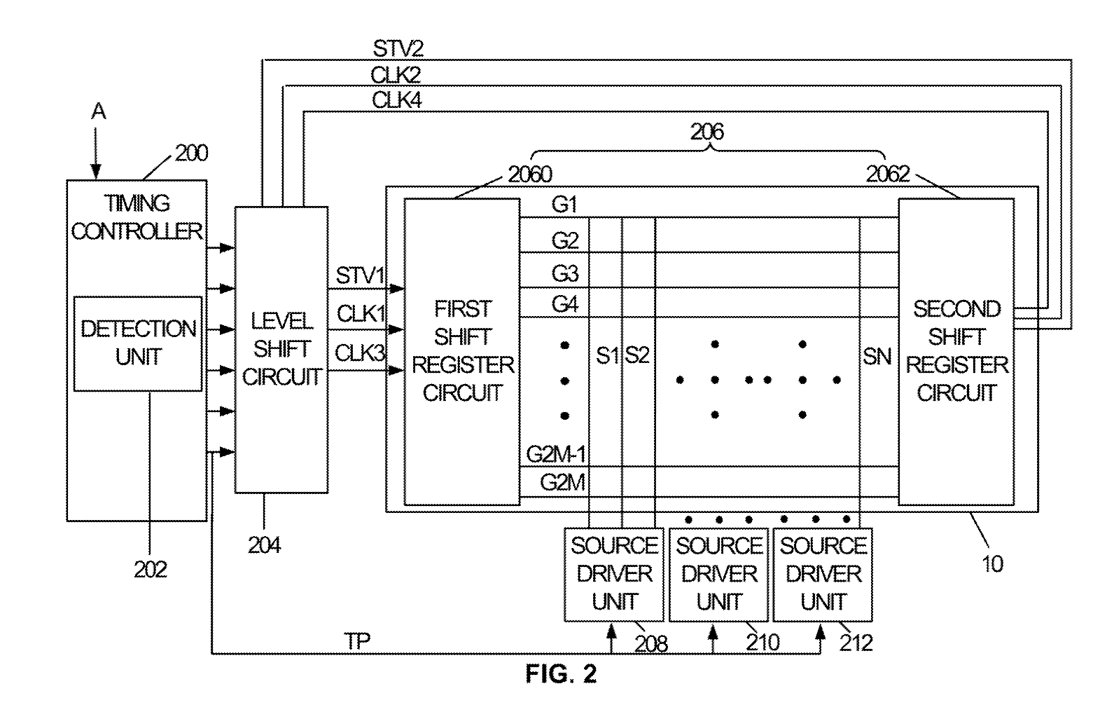

Please refer to FIG. 2, which illustrates a liquid crystal display device in accordance with the present invention. The liquid crystal display device comprises a liquid crystal panel 10 and a driver circuit. The liquid crystal panel 10 comprises a plurality of gate lines G1-G2M and a plurality of source lines S1-SN crossing the gate lines G1-G2M. The driver unit comprises a timing controller 200, a detection unit 202, a level shift circuit 204, a gate driver unit 206, and at least one source driver unit (represented by source driver units 208, 210, 212). The driver circuit drives the liquid crystal panel 10 to display an image.

Because the liquid crystal display device is a GIP type LCD device, the gate driver unit 206 is disposed on the liquid crystal panel 10. The gate driver unit 206 substitutes for the additional gate driver integrated circuits in the conventional liquid crystal display device. In the present embodiment, the gate driver unit 206 comprises a first shift register circuit 2060 and a second shift register circuit 2062 which are respectively manufactured at two sides of the liquid crystal panel 10. The first shift register circuit 2060 controls odd-numbered gate lines G1, G3 . . . G2M−1. The second shift register circuit 2062 controls even-numbered gate lines G2, G4 . . . G2M. Since the first and second shift register circuits 2060, 2062 are disposed on the liquid crystal panel 10 and the gate lines G1-G2M are controlled by separating into two sides of the liquid crystal panel 10, requiring control signals at least comprise gate starting signals STV1, STV2, and gate turn-on signals CLK1, CLK2, CLK3, CLK4. Functions of the control signals will be described in detail later. The level shift circuit 204 transmits the respective control signals to the level register circuits 2060, 2062. That is, the level shift circuit 204 transmits the gate starting signal STV1 and the gate turn-on signals CLK1, CLK3 to the level register circuit 2060 for controlling the odd-numbered gate lines G1, G3 . . . G2M−1. The level shift circuit 204 transmits the gate starting signal STV2 and the gate turn-on signals CLK2, CLK4 to the level register circuit 2062 for controlling the even-numbered gate lines G2, G4 . . . G2M. Moreover, the timing controller 200 transmits a source data writing signal to the source driver units 206, 208, 210 for controlling writing of data.

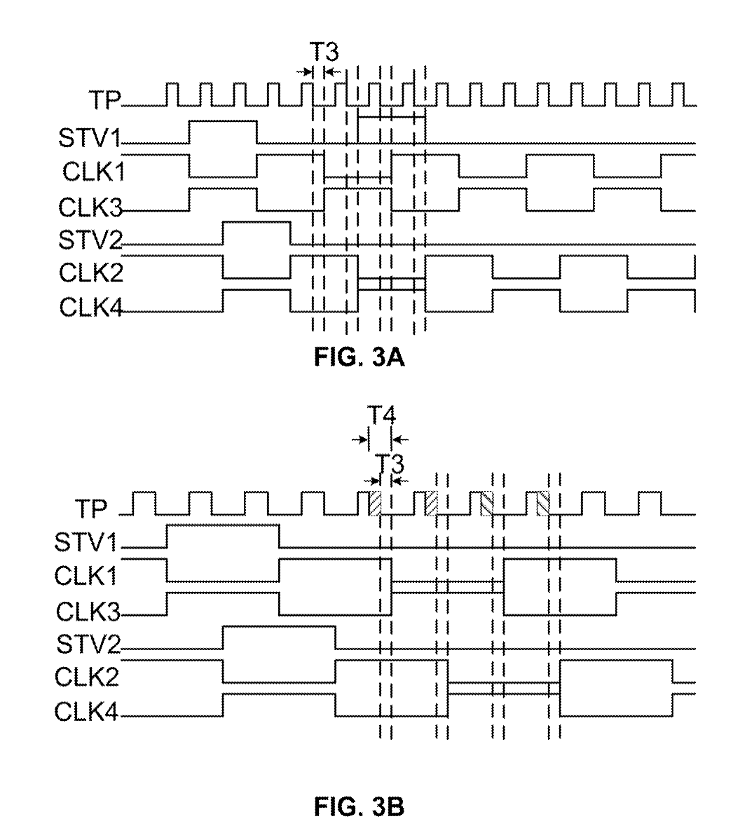

Since the gate driver integrated circuits are not utilized in the liquid crystal display device of the present invention, the control signals are different from those in the prior arts. Please refer to FIG. 3A, which illustrates a control signal timing chart of the liquid crystal display device of the present invention implementing the SDRRS technology at the frame rate of 60 Hz. When the source data writing signal TP is at a high level, the timing controller 200 transmits the data to the source driver integrated circuits 208, 210, 212. When the source data writing signal TP is at a low level, the source driver integrated circuits 208, 210, 212 transmit the data to the source lines S1-SN. The gate starting signals STV1, STV2 are enable signals. When the gate starting signal STV1 is switched from a high level to a low level, the gate turn-on signal CLK1 is enabled. When the gate starting signal STV2 is switched from a high level to a low level, the gate turn-on signal CLK2 is enabled. When the gate turn-on signals CLK1-CLK4 are at a high level, the gate lines G1-G4 are respectively turned on.

The timing of the control signals are described as follows. When the gate starting signal STV1 is at the high level, it is an indication that the gate line G1 is ready to be turned on. When the gate starting signal STV1 is switched from the high level to the low level, the gate turn-on signal CLK1 is enabled to be at the high level and thus the gate line G1 is turned on. During the high level of the gate turn-on signal CLK1, when the source data writing signal TP is at the high level for the first time, a polarity reversal is implemented across liquid crystals in the liquid crystal panel 10. The function of the polarity reversal is to prevent the liquid crystals from being driven by fixed voltages. During the high level of the gate turn-on signal CLK1, when the source data writing signal TP is at the high level for the second time, the timing controller 200 transmits the data of the source lines S1-SN to the source driver units 206, 208, 210. When the gate turn-on signal CLK1 turns on the gate line G1 (i.e. the gate turn-on signal CLK1 is at the high level) and the source data writing signal TP is at the low level, the source driver units 206, 208, 210 write the data of the source lines S1-SN to the source lines S1-SN. Finally, the gate turn-on signal CLK1 is at the low level, and thus the gate line G1 is turned off. In summary, a charge time of the gate line G1 is a time interval in which the gate line G1 is turned on according to the gate turn-on signal CLK1 (i.e. the gate turn-on signal CLK1 is at the high level) and the data of the source lines S1-SN are written to the source lines S1-SN according to the source data writing signal TP (i.e. the source data writing signal TP is at the low level). The charge time of the gate line G1 is represented as T3.

When the above-mentioned gate starting signal STV1 is at the high level, it is an indication to be ready to turn on the gate line G1. After the gate starting signal STV1 is at the high level and after a predetermined delay time, the gate starting signal STV2 is at the high level and it is an indication to be ready to turn on the gate line G2. The timing control of the gate line G2 is the same as that of the gate line G1. That is, when the gate starting signal STV2 is switched from the high level to the low level, the gate turn-on signal CLK2 is enabled to be at the high level and thus the gate line G2 is turned on. During the high level of the gate turn-on signal CLK2, when the source data writing signal TP is at the high level for the first time, a polarity reversal is implemented across the liquid crystals in the liquid crystal panel 10. The function of the polarity reversal is to prevent the liquid crystals from being driven by fixed voltages. During the high level of the gate turn-on signal CLK2, when the source data writing signal TP is at the high level for the second time, the timing controller 200 transmits the data of the source lines S1-SN to the source driver units 206, 208, 210. When the gate turn-on signal CLK2 turns on the gate line G2 (i.e. the gate turn-on signal CLK2 is at the high level) and the source data writing signal TP is at the low level, the source driver units 206, 208, 210 write the data of the source lines S1-SN to the source lines S1-SN. Finally, when the gate turn-on signal CLK2 is at the low level, the gate line G2 is turned off. In summary, a charge time of the gate line G2 is a time interval in which the gate line G2 is turned on according to the gate turn-on signal CLK2 (i.e. the gate turn-on signal CLK2 is at the high level) and the data of the source lines S1-SN are written to the source lines S1-SN according to the source data writing signal TP (i.e. the source data writing signal TP is at the low level). The charge time of the gate line G2 is represented as T3 the same as that of the gate line G1.

The timing control of the gate line G3 is described as follows. After the gate turn-on signal G1 at the high level is ending, the gate turn-on signal CLK3 is at the high level and thus the gate line G3 is turned on. During the high level of the gate turn-on signal CLK3, when the source data writing signal TP is at the high level for the first time, a polarity reversal is implemented across the liquid crystals in the liquid crystal panel 10. The function of the polarity reversal is to prevent the liquid crystals from being driven by fixed voltages. During the high level of the gate turn-on signal CLK3, when the source data writing signal TP is at the high level for the second time, the timing controller 200 transmits the data of the source lines S1-SN to the source driver units 206, 208, 210. When the gate turn-on signal CLK3 turns on the gate line G3 (i.e. the gate turn-on signal CLK3 is at the high level) and the source data writing signal TP is at the low level, the source driver units 206, 208, 210 write the data of the source lines S1-SN to the source lines S1-SN. Finally, when the gate turn-on signal CLK3 is at the low level, the gate line G3 is turned off. In summary, a charge time of the gate line G3 is a time interval in which the gate line G3 is turned on according to the gate turn-on signal CLK3 (i.e. the gate turn-on signal CLK3 is at the high level) and the data of the source lines S1-SN are written to the source lines S1-SN according to the source data writing signal TP (i.e. the source data writing signal TP is at the low level). The charge time of the gate line G3 is also represented as T3.

The timing control of the gate line G4 is described as follows. After the gate turn-on signal G2 at the high level is ending, the gate turn-on signal CLK4 is at the high level and thus the gate line G4 is turned on. During the high level of the gate turn-on signal CLK4, when the source data writing signal TP is at the high level for the first time, a polarity reversal is implemented across the liquid crystals in the liquid crystal panel 10. The function of the polarity reversal is to prevent the liquid crystals from being driven by fixed voltages. During the high level of the gate turn-on signal CLK4, when the source data writing signal TP is at the high level for the second time, the timing controller 200 transmits the data of the source lines S1-SN to the source driver units 206, 208, 210. When the gate turn-on signal CLK4 turns on the gate line G4 (i.e. the gate turn-on signal CLK4 is at the high level) and the source data writing signal TP is at the low level, the source driver units 206, 208, 210 write the data of the source lines S1-SN to the source lines S1-SN. Finally, when the gate turn-on signal CLK4 is at the low level, the gate line G4 is turned off. In summary, a charge time of the gate line G4 is a time interval in which the gate line G4 is turned on according to the gate turn-on signal CLK4 (i.e. the gate turn-on signal CLK4 is at the high level) and the data of the source lines S1-SN are written to the source lines S1-SN according to the source data writing signal TP (i.e. the source data writing signal TP is at the low level). The charge time of the gate line G4 is also represented as T3.

The gate lines G5-G8 are respectively turned on in sequence by the gate turn-on signals G1-G4, and the gate lines G9-12 are respectively turned on in sequence by the gate turn-on signals G1-G4, and so on.

Please refer to FIG. 3B, which illustrates a control signal timing chart of the liquid crystal display device of the present invention implementing the SDRRS technology at the frame rate of 40 Hz. The timing control in FIG. 3B is the same as that in FIG. 3A. A difference between FIG. 3A and FIG. 3B is that the frame rate in FIG. 3B is decreased from 60 Hz to 40 Hz, and thus a period of the source data writing signal TP is increased. Since a time interval in which the source data writing signal TP is at the high level is fixed, it is an indication that a time interval in which the source data writing signal TP is at the low level is increased. A charge time at the frame rate of 40 Hz is a time interval in which the source data writing signal TP is at the low level and the gate turn-on signal CLK1 is switched from the high level to the low level. The charge time at the frame rate of 40 Hz is represented as T4 shown in FIG. 3B. Since the charge time T4 at the frame rate of 40 Hz is different the charge time T3 at the frame rate of 60 Hz, the flickering phenomenon occurs when the frame rate is switched. A method to solve the flickering phenomenon in the present invention is to increase a duty cycle of the source data writing signal TP, that is, to increase the time interval in which the source data writing signal TP is at the high level so as to decrease the time interval in which the source data writing signal TP is at the low level. A diagonal area in FIG. 3B is the time interval in which the source data writing signal TP is at the high level. The time interval in which the source data writing signal TP is at the high level and the time interval in which the source data writing signal TP is at the low level are stored in the timing controller 200. As a result, the charge time T4 at the frame rate of 40 Hz is decreased to the charge time T3. That is, the charge time is maintained to be substantially constant (i.e. T3) regardless of the frame rate is 60 Hz or 40 Hz, whereby the flickering phenomenon can be avoided.

Please refer back to FIG. 2. Since the liquid crystal display device of the present invention is a GIP type LCD, the liquid crystal display device has to include the detection unit 202 for detecting whether or not the frame rate is switched. In the present embodiment, the detection unit 202 is disposed in the timing controller 200. In another embodiment, the detection unit 202 is disposed independently from the timing controller 202. When a frame rate A (60 Hz or 40 Hz) is inputted to the timing controller 200, the detection unit 202 detects the frame rate and selects the gate starting signals STV1, STV2, the gate turn-on signals CLK1, CLK2, CLK3, CLK4, and the source data writing signal TP corresponding to the detected frame rate A. Then, the gate starting signals STV1, STV2, the gate turn-on signals CLK1, CLK2, CLK3, CLK4, and the source data writing signal TP are transmitted to the level shift circuit 204 and the source driver units 208, 210, 212. The level shift circuit 204 and the source driver units 208, 210, 212 control the liquid crystal panel to display an image according to the control signal timing charts as shown in FIG. 3A and FIG. 3B.

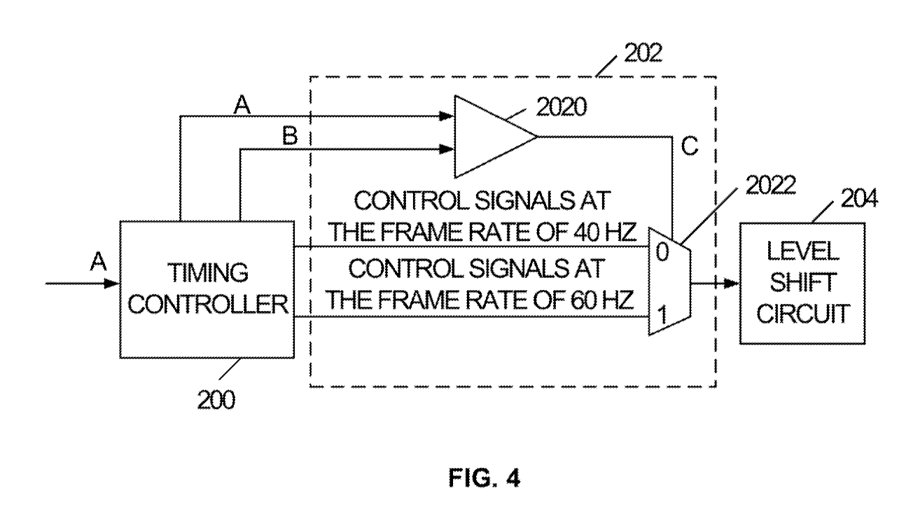

Please refer to FIG. 4, which illustrates an embodiment of the detection unit 202 in FIG. 2 and a detection principle of the detection unit 202. The detection unit 202 comprises a comparator 2020 and a multiplexer 2022. The comparator 2020 compares the frame rate A and a reference frame rate B. The reference frame rate B is a reference base and can be 60 Hz or 40 Hz. In the present embodiment, the reference rate B is 60 Hz. After the frame rate A is inputted to the timing controller 200, the timing controller 200 transmits the frame rate A and the reference frame rate B (60 Hz) to the comparator 2020. When the frame rate A is 60 Hz, a comparing result C of the comparator 2020 is “1” and the multiplexer 2022 selects and transmits the control signals corresponding to the frame rate of 60 Hz to the level shift circuit 204. When the frame rate A is switched from 60 Hz to 40 Hz, a comparing result C of the comparator 2020 is “0” and the multiplexer 2022 selects and transmits the control signals corresponding to the frame rate of 40 Hz to the level shift circuit 204.

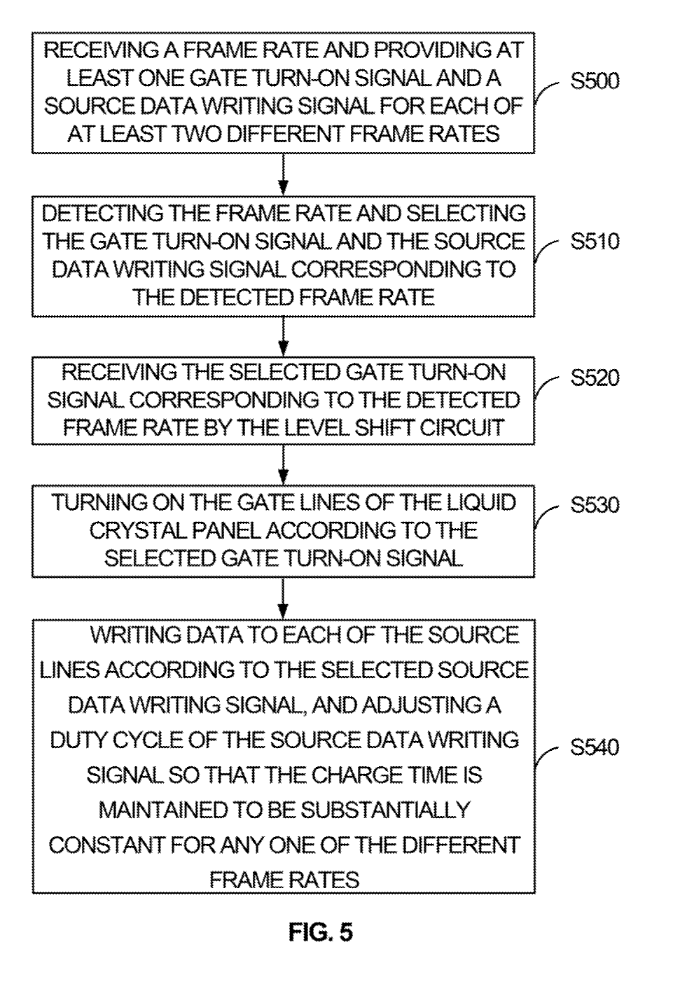

Please refer to FIG. 5, which illustrates a flow chart of a method for driving a liquid crystal display device according to the present invention. The liquid crystal display device comprises a liquid crystal panel and a driver circuit. The liquid crystal panel comprises a plurality of gate lines and a plurality of source lines crossing the gate lines. The driver unit comprises a timing controller, a detection unit, a level shift circuit, a gate driver unit disposed on the liquid crystal panel, and at least one source driver unit. The method comprises the following steps.

In Step 500, the timing controller receives a frame rate and provides at least one gate turn-on signal and a source data writing signal for each of at least two different frame rates. Furthermore, the timing controller provides at least one gate starting signal. When the gate starting signal is switched from the high level to the low level, the gate turn-on signal is enabled.

In Step 510, the detection unit detects the frame rate and selects the gate turn-on signal and the source data writing signal corresponding to the detected frame rate from the signals provided by the timing controller.

In Step 520, the level shift circuit receives the selected gate turn-on signal corresponding to the detected frame rate.

In Step 530, the level register unit turns on the gate lines of the liquid crystal panel according to the selected gate turn-on signal.

In Step 540, the source driver unit writes data to each of the source lines according to the selected source data writing signal. A charge time of each of the gate lines is a time interval in which the gate line is turned on by the gate driver unit according to the selected gate turn-on signal and the data is written to each of the source lines by the source driver unit according to the selected source data writing signal. The timing controller adjusts a duty cycle of the source data writing signal so that the charge time is maintained to be substantially constant for any one of the different frame rates.

In one embodiment, the shift register unit comprises a first shift register and a second shift register circuit for respectively controlling odd-numbered gate lines and even-numbered gate lines to be alternately turned on. The level shift circuit transmits the control signals corresponding to the first shift register circuit to the first shift register circuit. The level shift circuit transmits the control signals corresponding to the second shift register circuit to the second shift register circuit.

The detection unit comprises a comparator and a multiplexer. The Step S510 comprises the following steps. The comparator compares the received frame rate and a reference frame rate. The multiplexer selects the gate turn-on signal and the source data writing signal corresponding to the received frame rate according to a comparing result of the comparator.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A liquid crystal display device, comprising:
a liquid crystal panel, comprising a plurality of gate lines and a plurality of source lines crossing the gate lines; and
a driver circuit, driving the liquid crystal panel to display an image, the driver circuit comprising:
a timing controller, receiving a frame rate and providing at least one gate turn-on signal and a source data writing signal for each of at least two different frame rates;
a detection unit, detecting the frame rate and selecting the gate turn-on signal and the source data writing signal corresponding to the detected frame rate from the signals provided by the timing controller;
a level shift circuit, receiving the selected gate turn-on signal corresponding to the detected frame rate;
a gate driver unit, disposed on the liquid crystal panel, the gate driver unit controlling the gate lines of the liquid crystal panel according to the selected gate turn-on signal; and
at least one source driver unit, writing data to each of the source lines according to the selected source data writing signal;
wherein a charge time of each of the gate lines is a time interval in which the gate line is turned on by the gate driver unit according to the selected gate turn-on signal and the data is written to each of the source lines by the source driver unit according to the selected source data writing signal, and the timing controller adjusts a duty cycle of the source data writing signal so that the charge time is maintained to be substantially constant for any one of the different frame rates.

2. The liquid crystal display device as claimed in claim 1, wherein the detection unit is disposed in the timing controller.

3. The liquid crystal display device as claimed in claim 1, wherein the detection unit comprises:
a comparator, comparing the received frame rate and a reference frame rate; and
a multiplexer, selecting the gate turn-on signal and the source data writing signal corresponding to the received frame rate according to a comparing result of the comparator.

4. The liquid crystal display device as claimed in claim 1, wherein the timing controller further provides at least one gate starting signal, and the gate turn-on signal is enabled when the gate starting signal is switched from a high level to a low level.

5. The liquid crystal display device as claimed in claim 4, wherein the gate driver unit comprises a first shift register circuit and a second shift register circuit for respectively controlling odd-numbered gate lines and even-numbered gate lines.

6. The liquid crystal display device as claimed in claim 5, wherein the odd-numbered gate lines and the even-numbered gate lines are alternately turned on.

7. A method for driving a liquid crystal display device, the liquid crystal display device comprising a liquid crystal panel and a driver circuit, the liquid crystal panel comprising a plurality of gate lines and a plurality of source lines crossing the gate lines, the driver unit comprising a timing controller, a detection unit, a level shift circuit, a gate driver unit disposed on the liquid crystal panel, and at least one source driver unit, the method comprising:
receiving a frame rate and providing at least one gate turn-on signal and a source data writing signal for each of at least two different frame rates by the timing controller;
detecting the frame rate and selecting the gate turn-on signal and the source data writing signal corresponding to the detected frame rate from the signals provided by the timing controller by the detection unit;
receiving the selected gate turn-on signal corresponding to the detected frame rate by the level shift circuit;
turning on the gate lines of the liquid crystal panel according to the selected gate turn-on signal by the gate driver unit; and
writing data to each of the source lines according to the selected source data writing signal by the source driver unit;
wherein a charge time of each of the gate lines is a time interval in which the gate line is turned on by the gate driver unit according to the selected gate turn-on signal and the data is written to each of the source lines by the source driver unit according to the selected source data writing signal, and the timing controller adjusts a duty cycle of the source data writing signal so that the charge time is maintained to be substantially constant for any one of the different frame rates.

8. The method for driving the liquid crystal display device as claimed in claim 7, wherein the detection unit comprises a comparator and a multiplexer, the step of detecting the frame rate and selecting the gate turn-on signal and the source data writing signal corresponding to the detected frame rate by the detection unit comprises:
comparing the received frame rate and a reference frame rate by the comparator; and
selecting the gate turn-on signal and the source data writing signal corresponding to the received frame rate by the multiplexer according to a comparing result of the comparator.

9. The method for driving the liquid crystal display device as claimed in claim 7, wherein the timing controller further provides at least one gate starting signal, and the gate turn-on signal is enabled when the gate starting signal is switched from a high level to a low level.

10. The method for driving the liquid crystal display device as claimed in claim 9, wherein the gate driver unit comprises a first shift register circuit and a second shift register circuit for respectively controlling odd-numbered gate lines and even-numbered gate lines.

11. The method for driving the liquid crystal display device as claimed in claim 10, wherein the odd-numbered gate lines and the even-numbered gate lines are alternately turned on.
